(19) United States
(12) Patent Application Publication
(10) Pub. No.: US 2025/0058987 A1
(43) Pub. Date: Feb. 20, 2025

(54) RECORDING-MEDIUM-CONTAINER DEVICE AND IMAGE FORMING APPARATUS

(71) Applicant: FUJIFILM Business Innovation Corp., Tokyo (JP)

(72) Inventors: Kazuhiko HORIKAWA, Kanagawa (JP); Ryosuke YONESAKA, Kanagawa (JP); Yuichi ARAKI, Kanagawa (JP)

(73) Assignee: FUJIFILM Business Innovation Corp., Tokyo (JP)

(21) Appl. No.: 18/595,509

(22) Filed: Mar. 5, 2024

(30) Foreign Application Priority Data
Aug. 18, 2023 (JP) 2023-133627

(51) Int. Cl. B65H 1/04

(52) U.S. Cl. CPC B65H 1/04; B65H 2301/4461; B65H 2402/44; B65H 2553/42; B65H 2553/52; B65H 2553/81

(57) ABSTRACT

A recording-medium-container device includes a container configured to contain a stack of recording media; a blower configured to blow gas to the recording media contained in the container; and an image capturer movable in a stacking direction in which the recording media are stacked in the container, the image capturer being configured to capture an image of the recording media while the recording media are being blown with the gas by the blower.

### CROSS-REFERENCE TO RELATED APPLICATIONS

This application is based on and claims priority under 35 USC 119 from Japanese Patent Application No. 2023-133627 filed Aug. 18, 2023.

### BACKGROUND

### (i) Technical Field

The present disclosure relates to a recording-medium-container device and an image forming apparatus.

### (ii) Related Art

In Japanese Unexamined Patent Application Publication No. 2015-024868 is disclosed a sheet feeding device that includes an air sending component configured to blow air to a stack of sheets in such a manner as to cause the topmost one of the sheets to float, and a transporting component configured to attract the topmost sheet floated by the air sending component and transport the attracted sheet in a transporting direction.

### SUMMARY

In a configuration including an image capturer configured to capture an image of recording media that are being blown with gas, the state of the recording media that are being blown with the gas is checkable.

Depending on the state of the recording media that are being blown with the gas, the image of the recording media may be captured with the image capturer being away from an originally intended location.

Aspects of non-limiting embodiments of the present disclosure relate to a configuration in which an image capturer configured to capture an image of recording media that are being blown with gas is positionable closer to an originally intended location than in a configuration in which the position of the image capturer is not changeable.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a recording-medium-container device including a container configured to contain a stack of recording media; a blower configured to blow gas to the recording media contained in the container; and an image capturer movable in a stacking direction in which the recording media are stacked in the container, the image capturer being configured to capture an image of the recording media while the recording media are being blown with the gas by the blower.

### BRIEF DESCRIPTION OF THE DRAWINGS

An exemplary embodiment of the present disclosure will be described in detail based on the following figures, wherein:

FIG. 1 schematically illustrates an image forming apparatus;

FIG. 2 illustrates an exemplary hardware configuration of a controller;

FIGS. 3A to 3D illustrate a suction unit;

FIG. 4 is a perspective view of the suction unit seen in a direction indicated by arrow IV given in FIG. 3A;

FIG. 5 illustrates a sheet-container device seen in a direction indicated by arrow V given in FIG. 3A;

FIG. 6 illustrates the suction unit and a leading-edge blowing device seen from a lateral side of a sheet stack;

FIG. 7 illustrates the suction unit seen in a direction indicated by arrow VII given in FIG. 3B;

FIG. 8 illustrates a moving mechanism;

FIG. 9 illustrates a moving mechanism having another exemplary configuration;

FIGS. 10A to 10C illustrate different states of sheets that are being blown with air by a lateral blowing device;

FIGS. 11A to 11D illustrate the relationship between the position of an image capturer and the captured image;

FIG. 12 illustrates how the moving mechanism is controlled with reference to the inclination angle of an edge of a sheet;

FIG. 13 is a flow chart of a process to be executed by a central processing unit (CPU); and

FIG. 14 illustrates the image capturer and a sheet stack in which sheets are floating.

### DETAILED DESCRIPTION

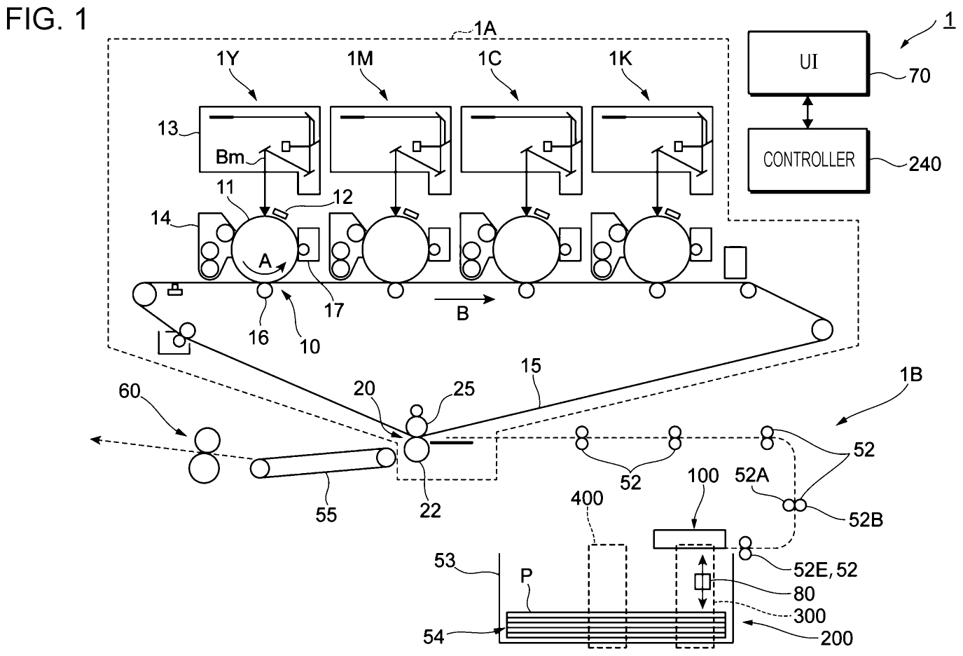

FIG. 1 schematically illustrates an image forming apparatus 1 according to an exemplary embodiment.

The image forming apparatus 1 illustrated in FIG. 1 is of a so-called tandem type and employs an intermediate transfer scheme. The image forming apparatus 1 includes an image forming section 1A, which is configured to form an image on a sheet P. The sheet P is an exemplary recording medium.

The image forming apparatus 1 further includes a sheet-container device 200, which is configured to contain sheets P. The image forming section 1A is to form an image on a sheet P that is delivered from the sheet-container device 200.

The image forming section 1A is an exemplary image forming component and includes a plurality of image forming units 1Y, 1M, 1C, and 1K, which are configured to electrophotographically form respective toner images in respective color components.

The image forming section 1A further includes first-transfer units 10, which are configured to sequentially transfer to an intermediate transfer belt 15 the toner images formed in the respective color components by the respective image forming units 1Y, 1M, 1C, and 1K. The image forming section 1A further includes a second-transfer unit 20, which is configured to collectively transfer to a sheet P the toner images superposed one on top of another on the intermediate transfer belt 15.

The image forming apparatus 1 further includes a fixing device 60, which is configured to fix the toner images transferred to the sheet P in the above second-transfer process.

The image forming apparatus 1 further includes a controller 240, which is configured to control operations of relevant elements; and a user interface (UI) 70, which is configured to receive information from the user and to display information to the user.

The UI 70 is, for example, a touch panel and has a receiving function of receiving information from the user and a display function of displaying information. The receiving function and the display function may be implemented by respective devices that are separate from each other.

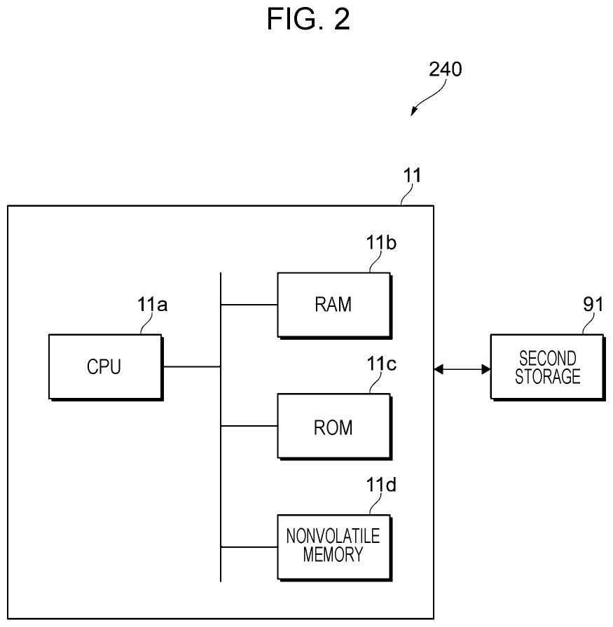

FIG. 2 illustrates an exemplary hardware configuration of the controller 240. The controller 240 is implemented as a computer.

The controller 240 includes an arithmetic processing unit 11, which is configured to execute digital arithmetic processing operations in accordance with programs; and a second storage 91, which is configured to store information.

The second storage 91 is implemented as a known information storage device such as a hard disk drive (HDD), a semiconductor memory, or a magnetic tape.

The arithmetic processing unit 11 includes a central processing unit (CPU) 11a, which is an exemplary processor.

The arithmetic processing unit 11 further includes a random access memory (RAM) 11b, which is used as a working memory or the like for the CPU 11a; and a read-only memory (ROM) 11c, which is configured to store information such as programs to be executed by the CPU 11a.

The arithmetic processing unit 11 further includes a nonvolatile memory 11d, which is rewritable and is capable of keeping data even in case of power outage.

The nonvolatile memory 11d is, for example, a static random access memory (SRAM) or flash memory that is provided with a battery backup. The second storage 91 is configured to store relevant pieces of information such as programs to be executed by the arithmetic processing unit 11.

In the present exemplary embodiment, the CPU 11a of the arithmetic processing unit 11 reads programs stored in the ROM 11c or the second storage 91, whereby relevant processing operations to be performed in the image forming apparatus 1 are executed.

The programs to be executed by the CPU 11a may be provided to the image forming apparatus 1 in a form stored in any computer-readable recording medium such as a magnetic recording medium (a magnetic tape, a magnetic disk, or the like), an optical recording medium (an optical disk or the like), a magneto-optical recording medium, or a semiconductor memory. The programs to be executed by the CPU 11a may alternatively be provided to the image forming apparatus 1 through any communications such as the Internet.

The term “processor” used herein refers to a processor in a broad sense and encompasses general-purpose processors (such as a central processing unit (CPU)) and dedicated processors (such as a graphics processing unit (GPU), an application-specific integrated circuit (ASIC), a field-programmable gate array (FPGA), and a programmable logic device).

Operations of the processor are not limited to those to be performed by a single processor and may be performed through a cooperation of a plurality of processors provided at different places that are physically apart from each other. The order of the operations of the processor is not limited to the one to be described in the present exemplary embodiment and may be changed.

The image forming apparatus I will further be described with reference to FIG. 1.

The image forming units 1Y, 1M, 1C, and 1K each include the following.

A photoconductor drum 11 is rotatable in a direction indicated by arrow A. Near the peripheral surface of the photoconductor drum 11 is provided a charging device 12, which is configured to charge the photoconductor drum 11. An exposure device 13 is configured to form an electrostatic latent image on the photoconductor drum 11. A developing device 14 is configured to develop the electrostatic latent image on the photoconductor drum 11 with a toner into a toner image.

In correspondence with the image forming units 1Y, 1M, 1C, and 1K are provided first-transfer rolls 16, which are configured to transfer the toner images in the respective color components on the respective photoconductor drums 11 to the intermediate transfer belt 15 in the respective first-transfer units 10.

The image forming units 1Y, 1M, 1C, and 1K each further include a drum cleaner 17, which is configured to remove residual toner particles and the like from the photoconductor drum 11.

The intermediate transfer belt 15 is to be rotated circularly in a direction indicated by arrow B in FIG. 1 and at a predetermined speed.

The first-transfer rolls 16 included in the first-transfer units 10 are located across the intermediate transfer belt 15 from the respective photoconductor drums 11.

In the present exemplary embodiment, the toner images formed on the respective photoconductor drums 11 are sequentially attracted to the intermediate transfer belt 15 with an electrostatic force, thereby being superposed one on top of another and thus integrated into a single toner image on the intermediate transfer belt 15.

The second-transfer unit 20 includes a second-transfer roll 22 and a backup roll 25. The second-transfer roll 22 is positioned facing the outer peripheral surface of the intermediate transfer belt 15.

The second-transfer roll 22 is pressed against the backup roll 25 with the intermediate transfer belt 15 in between. Across the second-transfer roll 22 and the backup roll 25 is to be applied a voltage. In the present exemplary embodiment, the toner image on the intermediate transfer belt 15 is transferred to a sheet P transported to the second-transfer unit 20.

In the present exemplary embodiment, the image forming apparatus 1 receives image data from an image-reading device, a personal computer (PC), or the like (not illustrated).

The received image data is processed by an image processor (not illustrated) into pieces of image data provided for the four respective colors of Y, M, C, and K. The pieces of image data are outputted to the respective exposure devices 13 provided for the respective colors of Y, M, C, and K.

In accordance with the pieces of image data received, the exposure devices 13 apply respective exposure beams Bm to the respective photoconductor drums 11 of the image forming units 1Y, 1M, 1C, and 1K from, for example, semiconductor lasers.

The exposure to be performed on the photoconductor drums 11 by the exposure devices 13 is not limited to a scheme using semiconductor lasers and may be another scheme using light beams emitted from light-emitting diodes (LEDs) serving as light sources.

The surfaces of the photoconductor drums 11 are first charged by the respective charging devices 12 and are then subjected to scan exposure performed by the respective exposure devices 13, whereby respective electrostatic latent images are formed.

Then, the developing devices 14 develop the electrostatic latent images on the respective photoconductor drums 11 into toner images, and the toner images are transferred to the intermediate transfer belt 15 in the respective first-transfer units 10, where the photoconductor drums 11 are in contact with the intermediate transfer belt 15.

After the toner images are sequentially transferred to the surface of the intermediate transfer belt 15 in the above first-transfer process into a single toner image, the toner image is transported to the second-transfer unit 20 with the rotation of the intermediate transfer belt 15.

In the second-transfer unit 20, the second-transfer roll 22 is pressed against the backup roll 25 with the intermediate transfer belt 15 in between.

In the present exemplary embodiment, the sheet P transported from the sheet-container device 200 is nipped between the intermediate transfer belt 15 and the second-transfer roll 22.

Thus, in the second-transfer unit 20, the toner image that is yet to be fixed on the intermediate transfer belt 15 is electrostatically transferred to the sheet P. Then, the sheet P having the toner image transferred thereto is transported to the fixing device 60 and is eventually outputted to a sheet output part (not illustrated).

The sheet-container device 200 is an exemplary recording-medium-container device and includes a container 53, which is configured to contain a stack of sheets P. The container 53 includes a support that is to support the sheets P from below, a side guide against which edges of the sheets P on one side are to be pressed for the positioning of the sheets P, and so forth.

In the present exemplary embodiment, the top one of the sheets P in the container 53 is to be delivered. The sheet P thus delivered receives in the second-transfer unit 20 the toner image formed by the image forming section 1A.

The sheet-container device 200 further includes an image capturer 80, which is configured to capture an image of the sheets P contained in the container 53.

The image capturer 80 includes, for example, a charge-coupled device (CCD) or a complementary metal-oxide semiconductor (CMOS). The image capturer 80 is not particularly limited and is at least capable of acquiring an image of the sheets P contained in the container 53. That is, the image capturer 80 may include any device other than the CCD or CMOS.

The image capturer 80 is located on one lateral side of the container 53.

The image capturer 80 is located facing one lateral face of a sheet stack 54, which is a stack of a plurality of sheets P contained in the container 53. More specifically, in the present exemplary embodiment, as to be described below, the sheets P in the sheet stack 54 are to be floated individually, and the image capturer 80 is to be positioned on one lateral side of the sheet stack 54 in a state where the sheets P are floating individually.

In the present exemplary embodiment, when the sheet stack 54 and the image capturer 80 are projected vertically upward or downward onto a horizontally extending virtual plane, the sheet stack 54 and the image capturer 80 are located not to overlap each other in the plane.

The image capturer 80 is movable in the top-bottom direction in FIG. 1. In other words, the image capturer 80 is movable in a stacking direction in which the sheets P are stacked in the container 53.

In the present exemplary embodiment, the image capturer 80 is movable by a moving mechanism 300 in, in FIG. 1, the top-bottom direction, which corresponds to the stacking direction of the sheets P.

The moving mechanism 300, which is an exemplary mover, includes a drive source (to be described below) and is configured to move the image capturer 80 in the stacking direction of the sheets P by using the drive source. In other words, the moving mechanism 300 uses the drive source to move the image capturer 80 in the top-bottom direction in FIG. 1.

In the present exemplary embodiment, a lateral blowing device 400 is provided as an exemplary blower. In the present exemplary embodiment, the lateral blowing device 400 is configured to blow air to a lateral face of the sheet stack 54 formed of the sheets P contained in the container 53.

Thus, in the present exemplary embodiment, the sheets P in the sheet stack 54 are to be floated individually.

In the present exemplary embodiment, air is used as a gas to be blown to the sheet stack 54. The kind of the gas is not particularly limited, and any gas other than air may be blown to the sheet stack 54.

The image capturer 80 captures an image of the sheets P while the sheets P are being blown with the gas by the lateral blowing device 400.

Thus, in the present exemplary embodiment, an image of the sheets P that are floating by being blown with the gas is captured. The image thus obtained is referred to as a captured image.

The sheet-container device 200 according to the present exemplary embodiment further includes a suction unit 100, which is located above the sheet stack 54 and is configured to apply suction to the sheets P forming the sheet stack 54.

In the present exemplary embodiment, a plurality of transporting rolls 52 are provided downstream of the sheet-container device 200 in the direction of transport of the sheet P. The transporting rolls 52 are configured to transport the sheet P delivered from the sheet-container device 200.

The transporting rolls 52 each include a driving roll 52A, which is configured to rotate by receiving a driving force generated by a motor (not illustrated); and a follower roll 52B, which is provided in contact with the driving roll 52A and is configured to rotate by receiving the driving force through the driving roll 52A.

In the present exemplary embodiment, the sheet P delivered from the sheet-container device 200 is first transported by one of the plurality of transporting rolls 52 that is located at the upstreammost position in the direction of transport of the sheet P (the one transporting roll 52 is hereinafter referred to as “upstreammost transporting roll 52E”).

The sheet P is further transported by the other transporting rolls 52 located downstream of the upstreammost transporting roll 52E and advances to the second-transfer unit 20 and then to the fixing device 60.

A transporting belt 55 is provided downstream of the second-transfer roll 22 in the direction of transport of the sheet P. The transporting belt 55 transports the sheet P having undergone the second-transfer process to the fixing device 60.

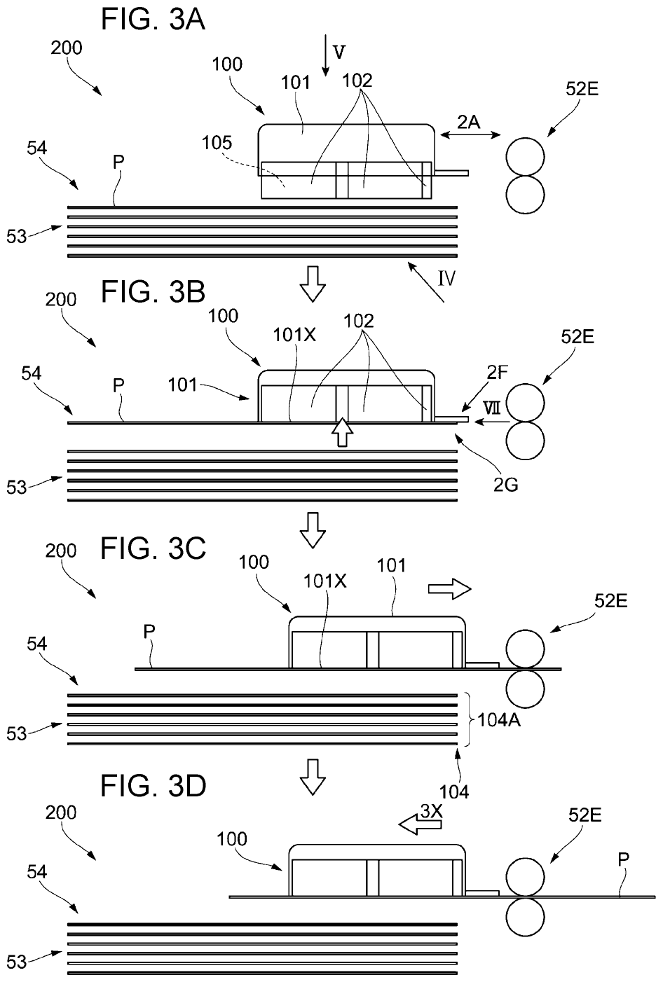

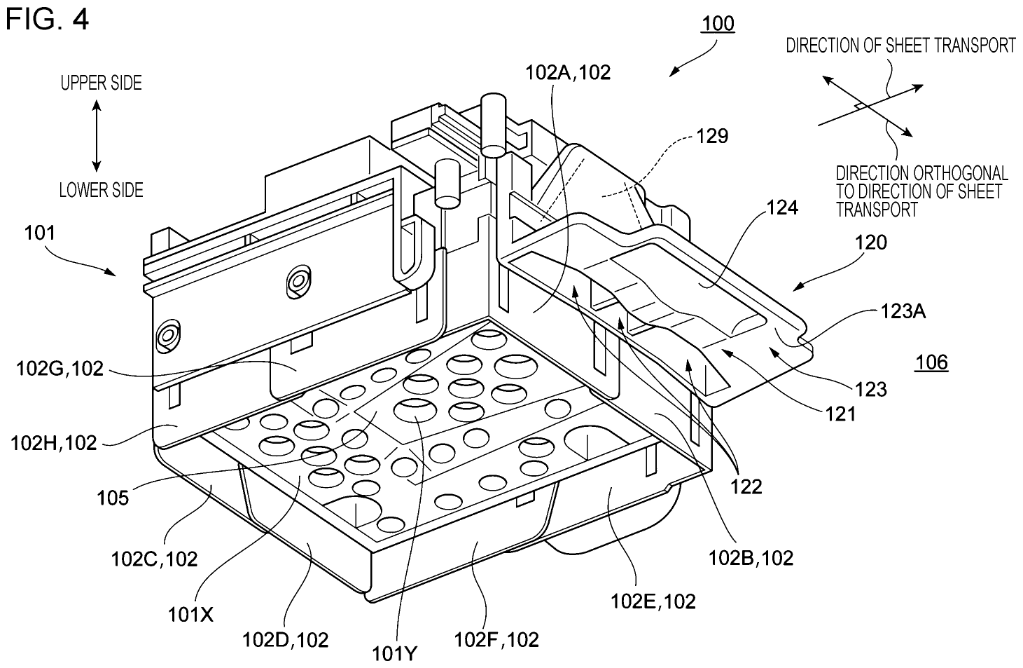

FIGS. 3A to 3D illustrate the suction unit 100. FIG. 4 is a perspective view of the suction unit 100 seen in a direction indicated by arrow IV given in FIG. 3A.

The sheets P illustrated in FIGS. 3A to 3D are floated with the air blown by the lateral blowing device 400 (see FIG. 1). The image capturer 80 and the lateral blowing device 400 are not illustrated in FIGS. 3A to 3D.

As illustrated in FIG. 3A, the sheet-container device 200 includes the suction unit 100 configured to apply suction to the sheets P stacked in the container 53. The sheet-container device 200 further includes a moving mechanism (not illustrated) configured to move the suction unit 100 in a direction indicated by arrow 2A in FIG. 3A.

The moving mechanism is not limited to a particular mechanism and may be based on a known mechanism including any of a motor, a gear, a rack and pinion, a belt-drive device, and the like.

In the present exemplary embodiment, the suction unit 100 is to be moved by the moving mechanism toward and away from the upstreammost transporting roll 52E as indicated by arrow 2A.

In the present exemplary embodiment, the suction unit 100 is to be moved by the moving mechanism from a position above the sheet stack 54 toward the upstreammost transporting roll 52E.

Furthermore, in the present exemplary embodiment, the suction unit 100 once moved toward the upstreammost transporting roll 52E by the moving mechanism is then moved toward the sheet stack 54 and returns to the position above the sheet stack 54.

As illustrated in FIG. 3A, the suction unit 100 includes a cuboidal unit body 101 and a plurality of movable members 102, which are hanging from the unit body 101.

The unit body 101 is provided with a suction tube (not illustrated). In the present exemplary embodiment, the unit body 101 applies suction to the sheets P, as to be described below, through the suction tube.

The movable members 102 are each a plate and are movable in the top-bottom direction.

As illustrated in FIG. 4, the movable members 102 are a first leading-end movable member 102A, a second leading-end movable member 102B, a first trailing-end movable member 102C, a second trailing-end movable member 102D, a first right-side movable member 102E, a second right-side movable member 102F, a first left-side movable member 102G, and a second left-side movable member 102H.

These eight movable members 102 separate a cuboidal depressurization space 105, which is defined below the unit body 101, from an atmospheric-pressure space 106, which surrounds the depressurization space 105.

The cuboidal space surrounded by the eight movable members 102 is regarded as the depressurization space 105. The space spreading outside the depressurization space 105 has an atmospheric pressure and is regarded as the atmospheric-pressure space 106.

The unit body 101 has a lower surface 101X, which has a plurality of holes 101Y. Air in the depressurization space 105 is suctioned through the holes 101Y. Consequently, the pressure in the depressurization space 105 becomes lower than the atmospheric pressure.

With the suction of the air in the depressurization space 105 to reduce the pressure in the depressurization space 105, as illustrated in FIGS. 3A and 3B, one of the sheets P that are present below the depressurization space 105 and are floating receives the suction and moves toward the lower surface 101X (see FIG. 3B) of the unit body 101.

Thus, the sheet P adheres to the lower surface 101X, which is an exemplary attracting part. In other words, in the present exemplary embodiment, the sheet P is attracted to the lower surface 101X. More specifically, in the present exemplary embodiment, the sheet P is attracted to the lower surface 101X from below.

The lower surface 101X serving an exemplary attracting part is a flat surface. In the present exemplary embodiment, the attracting part is a planar part, and the sheet P is to be attracted to the planar attracting part.

With the attraction of a sheet P to the lower surface 101X of the unit body 101, the eight movable members 102 illustrated in FIG. 4 move upward from the position illustrated in FIG. 3A to the position illustrated in FIG. 3B.

In the present exemplary embodiment, before a sheet P is attracted to the lower surface 101X illustrated in FIG. 4, the eight movable members 102 are pushed from below and are moved upward by a sheet P that is present therebelow. Since the eight movable members 102 are moved upward, the sheet P is attracted to the lower surface 101X of the unit body 101.

In the present exemplary embodiment, with the sheet P attracted to the lower surface 101X, air is blown from above the lower surface 101X as indicated by arrow 2F in FIG. 3B to an edge, 2G, of the sheet P attracted to the lower surface 101X.

More specifically, in the present exemplary embodiment, air is blown to the edge 2G of the sheet P attracted to the lower surface 101X from above the edge 2G.

The edge 2G illustrated in FIG. 3B is an edge of the sheet P that is located on the leading side of the sheet P while the sheet P is being transported (the edge 2G is hereinafter referred to as “leading edge 2G”). In the present exemplary embodiment, air is blown to the leading edge 2G from above.

The blowing of air to the leading edge 2G will be described in detail separately below.

In the present exemplary embodiment, after the blowing, the suction unit 100 moves toward the upstreammost transporting roll 52E as illustrated in FIG. 3C, whereby the sheet P attracted to the lower surface 101X of the unit body 101 is fed to the upstreammost transporting roll 52E.

Thus, the sheet P starts to be transported by the upstreammost transporting roll 52E.

In the present exemplary embodiment, the suction unit 100 moves in a direction intersecting the vertical direction and toward the upstreammost transporting roll 52E.

Consequently, the sheet P attracted to the lower surface 101X of the unit body 101 is fed to the upstreammost transporting roll 52E and starts to be transported by the upstreammost transporting roll 52E.

Then, in the present exemplary embodiment, the suction unit 100 moves in a direction indicated by arrow 3X in FIG. 3D and returns to the position above the sheet stack 54.

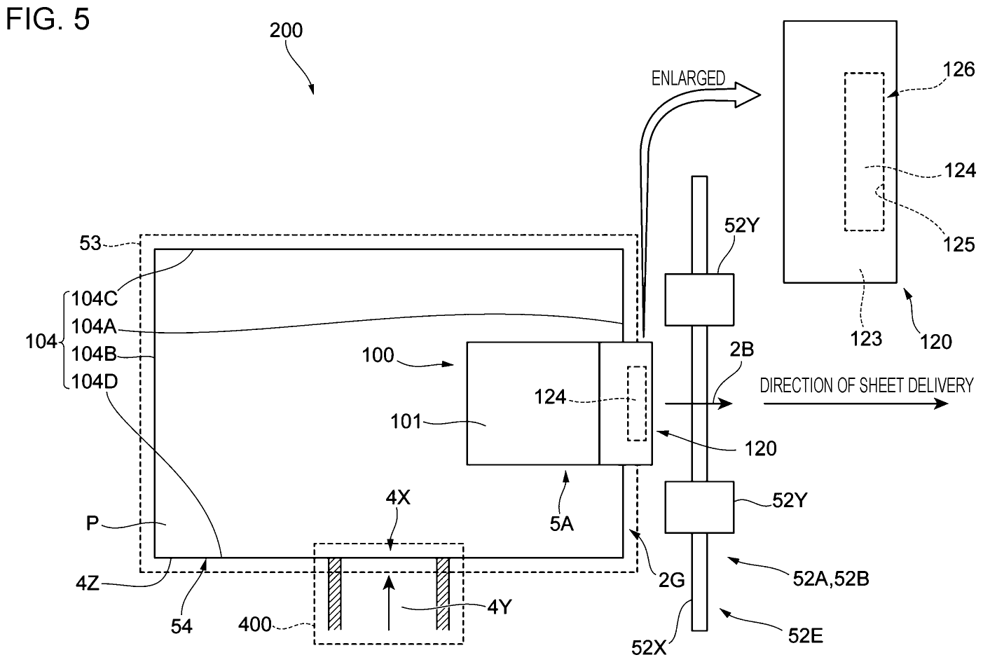

FIG. 5 illustrates the sheet-container device 200 seen in a direction indicated by arrow V given in FIG. 3A. In other words, FIG. 5 is a top view of the sheet-container device 200.

As illustrated in FIG. 5, in the present exemplary embodiment, a sheet stack 54 formed of a plurality of sheets P that are stacked in the thicknesswise direction of the sheets P is placed in the container 53. The sheet stack 54 and the individual sheets P included in the sheet stack 54 each have a rectangular peripheral edge 104.

The rectangular peripheral edge 104 is formed of a leading-side peripheral edge 104A, a trailing-side peripheral edge 104B, a first-side peripheral edge 104C, and a second-side peripheral edge 104D.

The leading-side peripheral edge 104A is a part of the peripheral edge 104 that is at the downstreammost position in the direction of transport of the sheet P. The leading-side peripheral edge 104A extends in a direction intersecting (orthogonal to) the direction of transport of the sheet P.

The trailing-side peripheral edge 104B is a part of the peripheral edge 104 that is at the upstreammost position in the direction of transport of the sheet P. The trailing-side peripheral edge 104B also extends in a direction intersecting (orthogonal to) the direction of transport of the sheet P.

The first-side peripheral edge 104C is a part of the peripheral edge 104 that connects one end of the leading-side peripheral edge 104A and one end of the trailing-side peripheral edge 104B to each other. The first-side peripheral edge 104C extends in the direction of transport of the sheet P.

The second-side peripheral edge 104D is a part of the peripheral edge 104 that connects the other end of the leading-side peripheral edge 104A and the other end of the trailing-side peripheral edge 104B to each other. The second-side peripheral edge 104D also extends in the direction of transport of the sheet P.

At the time of suction application to the sheets P, the unit body 101 of the suction unit 100 is positioned inward of the peripheral edge 104 of the sheet stack 54 as denoted by reference sign 5A in FIG. 5.

To feed a sheet P to the upstreammost transporting roll 52E, the suction unit 100 moves toward the upstreammost transporting roll 52E as indicated by arrow 2B.

In the present exemplary embodiment, as illustrated in FIG. 5, the lateral blowing device 400 is provided on one lateral side of the container 53.

In the present exemplary embodiment, the lateral blowing device 400 is located facing the second-side peripheral edge 104D of the sheet stack 54 contained in the container 53.

In the present exemplary embodiment, the sheet stack 54 has a cuboidal shape with four lateral faces, and the lateral blowing device 400 faces one of the four lateral faces.

Specifically, the lateral blowing device 400 faces a lateral face 4Z among the four lateral faces. The lateral face 4Z extends in the direction of delivery of the sheet P from the sheet-container device 200.

The location of the lateral blowing device 400 is not limited to the above. The lateral blowing device 400 may alternatively be located facing any of the first-side peripheral edge 104C, the leading-side peripheral edge 104A, and the trailing-side peripheral edge 104B.

In other words, the lateral blowing device 400 may alternatively be located facing any of the four lateral faces other than the lateral face 4Z.

Moreover, the number of blown position of the sheet stack 54 to which air is to be blown by the lateral blowing device 400 is not limited to one and may be two or more.

The lateral blowing device 400 serving as an exemplary blower includes an air-supply source (not illustrated) such as a fan and has an outlet 4X, from which air supplied from the air-supply source is to be discharged; and a flow path 4Y, which connects the air-supply source and the outlet 4X to each other.

The number of the outlet 4X is not particularly limited and may be one or two or more. If two or more outlets 4X are provided, two or more positions of the sheet stack 54 are to be blown with air by the lateral blowing device 400.

In the present exemplary embodiment, air is discharged from the outlet 4X toward a lateral face of the sheet stack 54 and is blown to the lateral face. The air thus blown to the lateral face of the sheet stack 54 flows into the gaps between the sheets P in the sheet stack 54 and causes the sheets P to float individually.

In the present exemplary embodiment, the driving roll 52A and the follower roll 52B of the upstreammost transporting roll 52E each include a rotation shaft 52X and a plurality of cylindrical members 52Y, which are each provided around the rotation shaft 52X.

In the present exemplary embodiment, the suction unit 100 moving toward the upstreammost transporting roll 52E advances into a gap between two of the cylindrical members 52Y and thus avoids interfering with the upstreammost transporting roll 52E.

Referring to FIG. 4, the configuration of the suction unit 100 will further be described.

The suction unit 100 includes the unit body 101 as described above. The unit body 101 is provided with an air guide 120, which is to guide air.

The air guide 120 has a rugged part 121, which is intended to make the leading edge 2G (see FIG. 5) of the sheet P wavy.

The rugged part 121 extends in a direction orthogonal to the direction of transport of the sheet P. More specifically, the rugged part 121 extends along the leading edge 2G of the sheet P.

In the present exemplary embodiment, with the attraction of a sheet P to the lower surface 101X of the unit body 101, the leading edge 2G of the sheet P is pressed against the rugged part 121 and thus comes to have a wavy shape.

In the present exemplary embodiment, the air guide 120 further has a suction opening 122, which is located closer to the lower surface 101X than the rugged part 121 in the horizontal direction and through which further suction is to be applied to the sheet P attracted to the lower surface 101X.

The air guide 120 further has an air guiding part 123, which is to guide the air to be blown to the leading edge 2G (see FIG. 5).

The air guiding part 123 has a recess 124, which is recessed upward.

More specifically, the recess 124 of the air guiding part 123 is provided in a lower surface 123A in such a manner as to be recessed upward. The recess 124 is in the form of a groove. The recess 124 extends along the leading edge 2G of the sheet P (see FIG. 5).

In the present exemplary embodiment, as illustrated in FIG. 5, the lower surface 123A of the air guiding part 123 (see FIG. 4) has a rectangular opening 125. The recess 124 that is recessed upward as illustrated in FIG. 4 is a space above the opening 125. Herein, the space above the opening 125 refers to a space spreading vertically above the opening 125.

In the present exemplary embodiment, as illustrated in FIG. 5, the opening 125 is defined by an opening edge 126. The opening edge 126 has a rectangular shape.

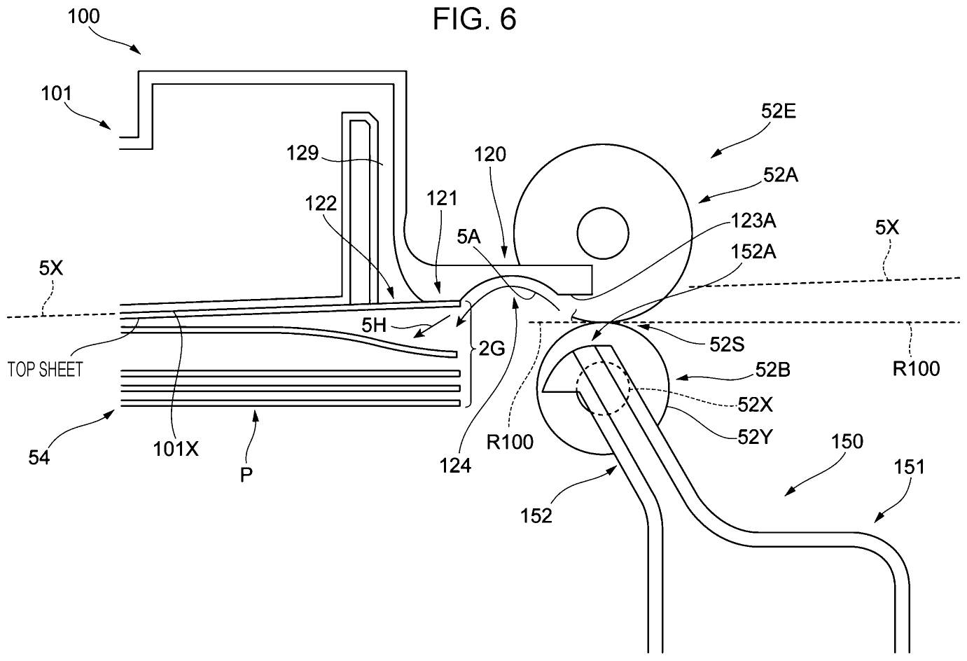

FIG. 6 illustrates the suction unit 100 and a leading-edge blowing device 150 seen from a lateral side of the sheet stack 54.

In other words, FIG. 6 illustrates the suction unit 100 and the leading-edge blowing device 150 seen from a position facing one of the lateral faces of the sheet stack 54 that extends in the direction of delivery of the sheet P.

In the present exemplary embodiment, in addition to the lateral blowing device 400 (not illustrated in FIG. 6) described above, the leading-edge blowing device 150 is provided as illustrated in FIG. 6 to blow air to the leading edges 2G of the sheets P.

The leading-edge blowing device 150 includes an air-supply source 151 such as a fan; and a tube 152, through which the air sent from the air-supply source 151 is to be guided obliquely upward.

The air-supply source 151 and the tube 152 are located lower than the lower surface 101X of the unit body 101.

The tube 152 has at the distal end thereof an outlet 152A, from which the air is to be discharged to flow toward the recess 124 of the air guide 120.

In the present exemplary embodiment, as indicated by arrow 5A, the air discharged from the outlet 152A first travels to a position higher than the lower surface 101X and then travels downward to be blown to the leading edges 2G from the position higher than the lower surface 101X.

In the present exemplary embodiment, the air travels from a position lower than an extension plane, 5X, of the lower surface 101X and reaches a position higher than the extension plane 5X. Then, the air travels downward to a position lower than the extension plane 5X, thereby being blown to the leading edges 2G.

In the present exemplary embodiment, the air from the air-supply source 151 is first guided upward through the tube 152 and then travels downward. Eventually, in the present exemplary embodiment, the downward air is blown to the leading edges 2G of the sheets P.

In the present exemplary embodiment, the air supplied from a position lower than the lower surface 101X of the unit body 101 is guided along the recess 124 of the air guide 120 to travel downward. Eventually, the downward air is blown to the leading edges 2G of the sheets P.

In the present exemplary embodiment, the driving roll 52A and the follower roll 52B of the upstreammost transporting roll 52E are in contact with each other at a contact part 52S, and the outlet 152A is located lower than the contact part 52S.

In the present exemplary embodiment, the air having traveled through the tube 152 is discharged from the outlet 152A provided at the distal end of the tube 152. The outlet 152A is located lower than the contact part 52S between the driving roll 52A and the follower roll 52B.

In the present exemplary embodiment, the tube 152 that guides the air upward does not cross a transport path R100, along which the sheet P is to be transported. In the present exemplary embodiment, the outlet 152A of the tube 152 is located lower than the transport path R100 for the sheet P. Therefore, in the present exemplary embodiment, the air alone crosses the transport path R100 for the sheet P.

The air having crossed the transport path R100 travels toward the recess 124. Then, the air is guided along the recess 124 and is blown to the leading edges 2G.

In the present exemplary embodiment, to blow air to the leading edges 2G from above, the air is sent obliquely downward as indicated by arrow 5H, whereby, the obliquely downward air is blown to the leading edges 2G.

More specifically, in the present exemplary embodiment, air is sent from a position that is higher than and apart from the leading edge 2G of one of the sheets P that is attracted to the lower surface 101X, and then travels obliquely downward to be blown to the leading edge 2G.

In the present exemplary embodiment, the follower roll 52B of the upstreammost transporting roll 52E includes two cylindrical members 52Y, and the rotation shaft 52X of the follower roll 52B is provided for each of the two cylindrical members 52Y. That is, the follower roll 52B has two rotation shafts 52X.

In the present exemplary embodiment, the tube 152 included in the leading-edge blowing device 150 is located in the gap between the two rotation shafts 52X, so that the leading-edge blowing device 150 and the follower roll 52B do not interfere with each other.

In the present exemplary embodiment, to transport a sheet P from those stacked in the container 53, as illustrated in FIGS. 3A and 3B, the top one of the sheets P that are floating is first attracted to the suction unit 100.

Furthermore, as indicated by arrow 2F in FIG. 3B, air is blown by the leading-edge blowing device 150 (not illustrated in FIG. 3B) obliquely downward from above the leading edges 2G of the sheets P, whereby the air is blown to the leading edges 2G.

Then, in the present exemplary embodiment, as illustrated in FIG. 3C, the suction unit 100 moves toward the upstreammost transporting roll 52E, whereby the sheet P attracted to the suction unit 100 is fed to the upstreammost transporting roll 52E.

In the present exemplary embodiment, the suction unit 100 is moved neither upward nor downward in attracting the sheet P. However, the behavior of the suction unit 100 is not limited to the above. The suction unit 100 may be lowered to pick up a sheet P and be lifted after the sheet P is attracted to the suction unit 100.

If the adhesion between the sheets P is large, the second and subsequent sheets P that are present below the top sheet P attracted to the suction unit 100 may remain adhering to the top sheet P. Such a situation may lead to so-called multiple feeding, in which a plurality of sheets P are fed to the upstreammost transporting roll 52E.

In the present exemplary embodiment, to reduce the occurrence of multiple feeding, as described above, air is blown to the leading edges 2G from above.

In the present exemplary embodiment, to further reduce the probability of adhesion between the sheets P, the lateral blowing device 400 illustrated in FIGS. 1 and 5 is used to blow air to a lateral face of the sheet stack 54 from a corresponding lateral side of the sheet stack 54.

When air is blown to the lateral face of the sheet stack 54, the air flows into the gaps between the sheets P, whereby the adhesion between the sheets P is lowered. In the present exemplary embodiment, when air is blown to the lateral face of the sheet stack 54, the air flows into the gaps between the sheets P and causes the sheets P to float individually.

In the present exemplary embodiment, the lateral blowing device 400 and the leading-edge blowing device 150 also blow air while the suction unit 100 is moving toward the upstreammost transporting roll 52E.

In the present exemplary embodiment, the blowing of air to the sheet stack 54 is constantly performed; that is, the blowing of air by the lateral blowing device 400 and the leading-edge blowing device 150 is also performed while the suction unit 100 is moving.

However, the scheme of air blowing is not limited to the above. While the suction unit 100 is moving toward the upstreammost transporting roll 52E, the air blowing by the leading-edge blowing device 150 may be stopped or the amount of air supplied by the leading-edge blowing device 150 may be reduced.

Referring to FIG. 4, the suction unit 100 will further be described.

In the present exemplary embodiment, as described above, the air guide 120 has the suction opening 122 located closer to the lower surface 101X than the rugged part 121 in the horizontal direction and through which further suction is to be applied to the sheet P attracted to the lower surface 101X.

In the present exemplary embodiment, once a sheet P is attracted to the lower surface 101X, the suction through the suction opening 122 starts to be applied to the sheet P.

In the present exemplary embodiment, as illustrated in FIG. 4, the suction opening 122 and the inside of the unit body 101 are connected to each other through a connecting path 129, and the inside of the connecting path 129 is to be depressurized. As illustrated in FIG. 4, the connecting path 129 is shaped with the width thereof (the length along the leading edges 2G (sec FIG. 5)) gradually increasing downward.

In the present exemplary embodiment, before a sheet P is attracted to the lower surface 101X, there is a gap between the sheet P and the suction opening 122, so that the suction through the suction opening 122 is not applied to the sheet P.

Once a sheet P is attracted to the lower surface 101X, the gap between the sheet P and the suction opening 122 is removed, whereby the suction through the suction opening 122 is applied to the sheet P.

When the suction through the suction opening 122 is applied to the sheet P, the leading edge 2G of the sheet P is urged to and pressed against the rugged part 121.

Thus, the leading edge 2G comes to have a rugged shape. In other words, the leading edge 2G comes to have a wavy shape.

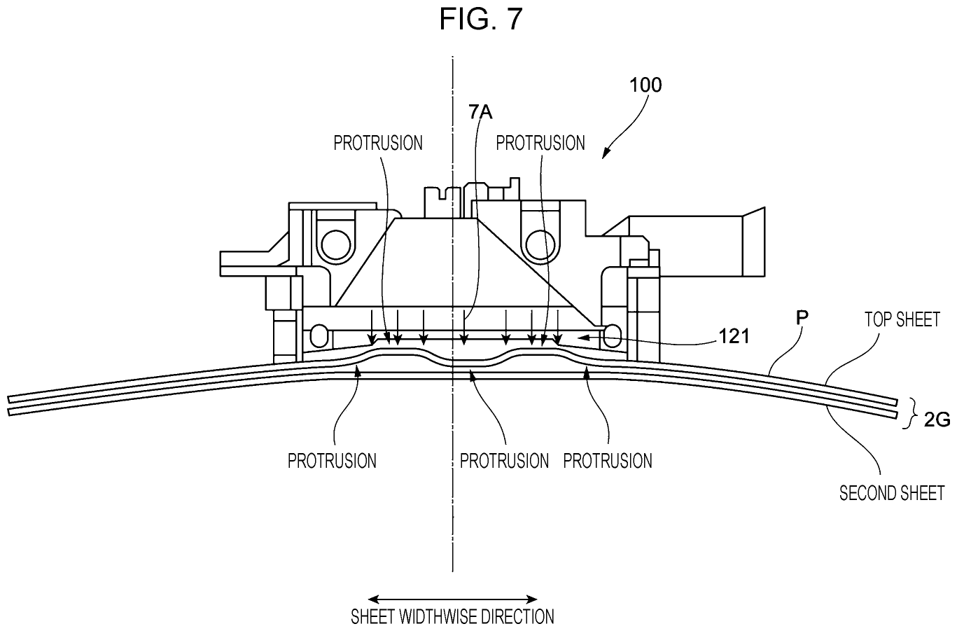

FIG. 7 illustrates the suction unit 100 seen in a direction indicated by arrow VII given in FIG. 3B.

In the present exemplary embodiment, as indicated by arrows 7A, air is blown to the leading edge 2G from above the leading edge 2G, aiming at the wavy part of the leading edge 2G.

In the present exemplary embodiment, as described above, the leading edge 2G of the sheet P is pressed against the rugged part 121, whereby the leading edge 2G of the sheet P comes to have a wavy shape.

In the present exemplary embodiment, the air blown from above is aimed at the wavy part.

Herein, the term “wavy shape” refers to a shape formed by an alternate arrangement, in a direction along the leading edge 2G, of first protrusions and second protrusions. The first protrusions protrude from one side to the other side of the sheet P in the thicknesswise direction of the sheet P. The second protrusions protrude from the other side to the one side of the sheet P in the thicknesswise direction of the sheet P.

Herein, the number of the first protrusions and the number of the second protrusions are not particularly limited. An arrangement in which one first protrusion and one second protrusion are formed side by side is also regarded as a wavy shape.

As another exemplary embodiment, air may be blown to the leading edge 2G directly from above.

In the above description, after the air from the air-supply source 151 located lower than the leading edge 2G is blown upward, the air is redirected downward to be blown to the leading edge 2G from above. The blowing is not limited to such a scheme.

For example, an air-supply source such as a fan may be provided at a position higher than the lower surface 101X of the unit body 101 so that air is blown to the leading edge 2G directly from above.

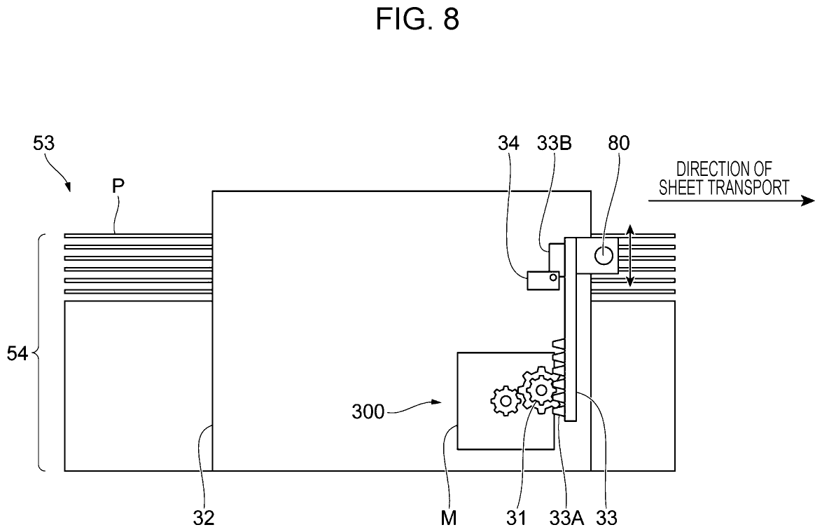

FIG. 8 illustrates the moving mechanism 300.

In the present exemplary embodiment, as described above and as illustrated in FIG. 8, the image forming apparatus 1 includes the image capturer 80 configured to capture an image of the sheet stack 54, and the moving mechanism 300 configured to move the image capturer 80 in the stacking direction of the sheets P.

The moving mechanism 300 is supported by a side guide 32, which is included in the container 53. In the present exemplary embodiment, edges of the sheets P on one side are to be pressed against the side guide 32 for the positioning of the sheets P.

The moving mechanism 300 includes a motor M, which is an exemplary drive source; a pinion gear 31, which is to be rotated by the motor M; and a movable part 33, which is to be moved up and down by the pinion gear 31.

The movable part 33 has rack gear teeth 33A, which are arranged side by side in a direction in which the movable part 33 extends. The movable part 33 is movable up and down by receiving at the rack gear teeth 33A a force transmitted through the pinion gear 31.

The moving mechanism 300 further includes a sensor 34, which is intended to identify the position of the movable part 33.

In the present exemplary embodiment, while a detection object 33B, which is provided on the movable part 33, is being detected by the sensor 34, the CPU 11a determines that the image capturer 80 is at a reference position.

The CPU 11a identifies the position of the image capturer 80 with reference to the length traveled by the image capturer 80 from the reference position.

More specifically, for example, if the motor M is a stepping motor, the CPU 11a identifies the position of the image capturer 80 with reference to the number of steps taken by the motor M for the rotation from a position thereof where the image capturer 80 is at the reference position.

When the motor M of the moving mechanism 300 is activated, the movable part 33 moves up or down, whereby the image capturer 80 moves up or down correspondingly.

The moving mechanism 300 is controlled by the CPU 11a (see FIG. 2) serving as an exemplary processor. In the present exemplary embodiment, a control signal is transmitted from the CPU 11a to the moving mechanism 300, whereby the motor M rotates to cause the image capturer 80 to move up or down.

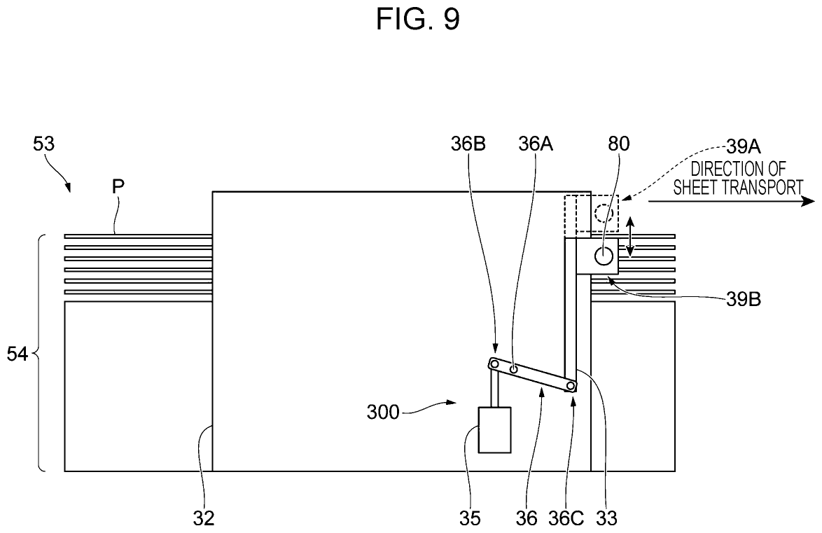

FIG. 9 illustrates a moving mechanism 300 having another exemplary configuration.

The drive source included in the moving mechanism 300 having the exemplary configuration illustrated in FIG. 9 is a solenoid 35.

The present exemplary configuration includes a rotatable part 36, which extends laterally in FIG. 9 and is to be rotated about a rotation shaft 36A by the solenoid 35 such that the left end, 36B, of the rotatable part 36 moves up and down.

The right end, 36C, of the rotatable part 36 is connected to a movable part 33, which supports the image capturer 80.

In the present exemplary configuration, the CPU 11a turns on or off the solenoid 35, whereby the rotatable part 36 rotates to cause the movable part 33 to move up or down. With the up or down movement of the movable part 33, the image capturer 80 moves up or down.

In the exemplary configuration illustrated in FIG. 8, the image capturer 80 is stoppable at any position. In contrast, in the exemplary configuration illustrated in FIG. 9, the image capturer 80 is stoppable at two stop positions: an upper stop position 39A, which is a stop position defined on the upper side; and a lower stop position 39B, which is a stop position defined on the lower side.

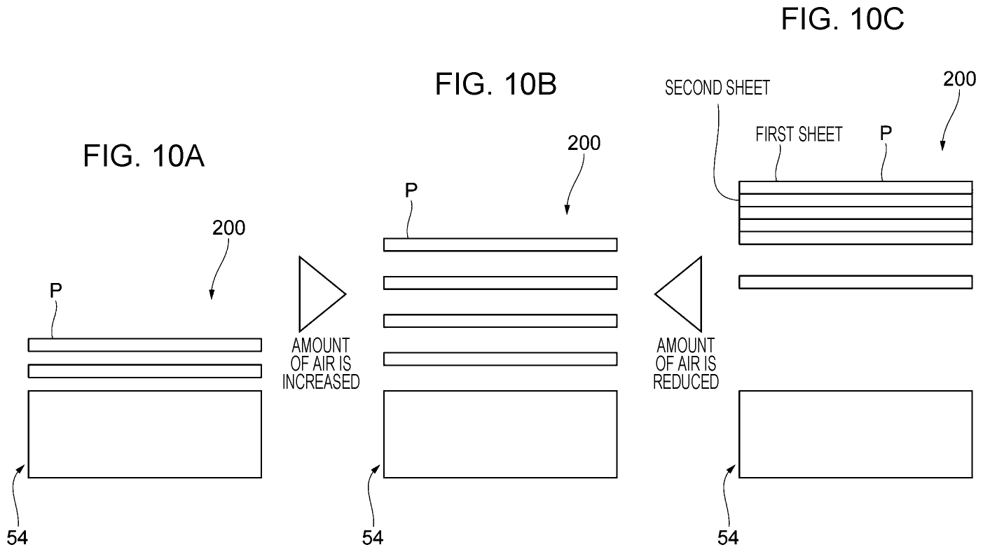

FIGS. 10A to 10C illustrate different states of sheets P that are being blown with air by the lateral blowing device 400. The lateral blowing device 400 is not illustrated in FIGS. 10A to 10C.

FIG. 10B illustrates a state of the sheets P where the amount of air blown by the lateral blowing device 400 matches relevant conditions of the sheets P forming the sheet stack 54. In such a state, the air flows into the gaps between the sheets P and causes the sheets P to float individually.

In contrast, FIG. 10A illustrates a state where the amount of air blown by the lateral blowing device 400 is short. In such a state, none of the sheets P reaches the suction unit 100 (see FIG. 1), leading to a possible failure in the transport of the sheet P.

FIG. 10C illustrates a state where the amount of air blown by the lateral blowing device 400 is excessive. In such a state, a plurality of sheets P are present immediately below the suction unit 100 (see FIG. 1), increasing the probability of multiple feeding.

In other words, in the state illustrated in FIG. 10C, one of the sheets P immediately below the suction unit 100 that is at the first place counting from the side of the suction unit 100 is adhered to another sheet P that is at the second place counting from the side of the suction unit 100, increasing the probability of multiple feeding.

In the present exemplary embodiment, the image capturer 80 (see FIG. 1) is used to capture an image of the sheet stack 54, so that which of the states illustrated in FIGS. 10A to 10C the sheet stack 54 that are being blown with air by the lateral blowing device 400 is in is identifiable.

In the present exemplary embodiment, as to be described below, the image capturer 80 is to be moved for increased accuracy in the identification.

In the present exemplary embodiment, the state of the sheet stack 54 is identifiable through an image of the sheet stack 54 that is captured by the image capturer 80. However, depending on the position of the image capturer 80, the accuracy in the identification may be reduced. Hence, in the present exemplary embodiment, the image capturer 80 is to be moved for increased accuracy in the identification.

More specifically, depending on the position of the image capturer 80, the state of the sheet stack 54 that is illustrated in FIG. 10B may be mistakenly determined as the state illustrated in FIG. 10C, resulting in reduced accuracy in the identification of the state of the sheet stack 54.

In the present exemplary embodiment, the image capturer 80 is to be moved to obtain increased accuracy in the identification of the state of the sheet stack 54.

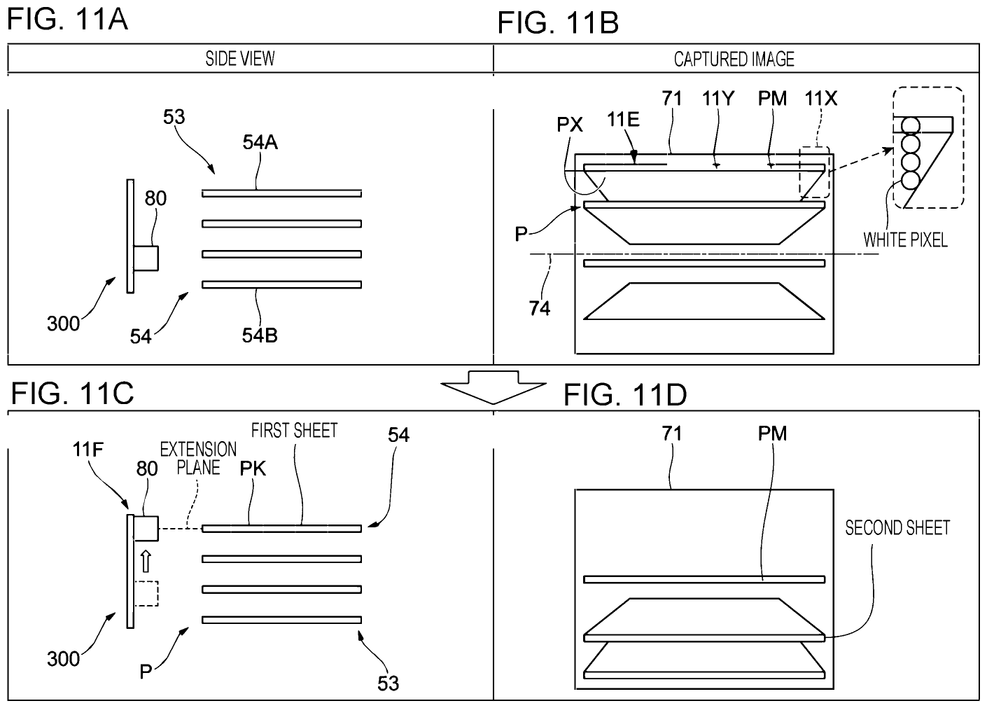

FIGS. 11A to 11D illustrate the relationship between the position of the image capturer 80 and the captured image obtained by the image capturer 80.

In the present exemplary embodiment, as illustrated in FIG. 11A, when the image capturer 80 is at a position between the upper end, 54A, and the lower end, 54B, of the sheet stack 54 that is in a floated state, a captured image illustrated in FIG. 11B is obtained.

With the captured image illustrated in FIG. 11B, it is difficult to determine which of the states illustrated in FIGS. 10B and 10C the sheet stack 54 is in.

In the present exemplary embodiment, the CPU 11a is configured to determine which of the states illustrated in FIGS. 10A to 10C the sheet stack 54 is in with reference to the number of white pixels that are lined in a downward direction, counting from one of the white pixels in the captured image that is closest to the upper edge, 71, of the captured image (see FIG. 11B).

The white pixel is a pixel representing a part of the sheet P. In the present exemplary embodiment, the state of the sheet stack 54 is to be identified with reference to the number of white pixels.

More specifically, defining one of the white pixels that is closest to the upper edge 71 as the first white pixel, the CPU 11a counts, from the first white pixel, the number of white pixels that are lined continuously downward in the captured image and identifies the thus counted number as the number of pixels.

With reference to the thus identified number of pixels (hereinafter referred to as “the number of downward continuous pixels”), the CPU 11a determines which of the states illustrated in FIGS. 10A to 10C the sheet stack 54 is in.

Normally, if a single sheet P is present alone at the topmost position among the sheets P in the captured image, the number of downward continuous pixels is small. If the number of downward continuous pixels is smaller than or equal to a predetermined threshold, the CPU 11a determines that a single sheet P is present at the topmost position.

If a plurality of sheets P are adhered to one another at the topmost position, the number of downward continuous pixels is large. If the number of downward continuous pixels is greater than the predetermined threshold, the CPU 11a determines that a plurality of sheets P are adhered to one another at the topmost position.

The captured image illustrated in FIG. 11B represents a case where the number of downward continuous pixels is greater than the predetermined threshold, with some white pixels being lined continuously in the top-bottom direction in an area 11X.

In such a case, the CPU 11a mistakenly determines that the sheet stack 54 is in the state illustrated in FIG. 10C, despite that the sheet stack 54 is actually in the state illustrated in FIG. 10B.

In the captured image illustrated in FIG. 11B, although a single sheet P is present alone at the topmost position, which is denoted by reference sing 11Y, the number of downward continuous pixels is large because of the representation of the lower surface, PX, of the sheet P at the topmost position in the captured image.

In such a case, the CPU 11a mistakenly determines that the sheet stack 54 is in the state illustrated in FIG. 10C.

In the present exemplary embodiment, the occurrence of such a mistaken determination is reduced through an operation of moving the image capturer 80. The operation of moving the image capturer 80 will now be described. The following description relates to an operation using the moving mechanism 300 illustrated in FIG. 8.

In the present exemplary embodiment, before the operation of moving the image capturer 80 is started, an image of the sheet stack 54 that is being blown with air by the lateral blowing device 400 is captured by using the image capturer 80, whereby a captured image is obtained as a result of the image capturing.

If the captured image is regarded as, for example, the one illustrated in FIG. 11B, the CPU 11a controls the moving mechanism 300 to move the image capturer 80.

If the captured image is regarded as the one illustrated in FIG. 11B, the CPU 11a serving as an exemplary processor controls the moving mechanism 300 to move the image capturer 80 to a position where the above mistaken determination is less likely to occur.

The CPU 11a is configured to control the moving mechanism 300 with reference to the captured image obtained by the image capturer 80. In other words, the CPU 11a is configured to control the moving mechanism 300 with reference to the state of the sheets P that are represented in the captured image.

More specifically, the CPU 11a is configured to control the moving mechanism 300 with reference to the position of a relevant one of the sheets P represented in the captured image or the inclination angle of an edge of the relevant sheet P.

Thus, the image capturer 80 is moved to a position where the mistaken determination is less likely to occur.

If, for example, the captured image illustrated in FIG. 11B is obtained, the CPU 11a controls the moving mechanism 300 with reference to the position of the relevant sheet P in the captured image.

Specifically, the CPU 11a controls the moving mechanism 300 with reference to the position of, among the sheets P represented in the captured image, a sheet P that satisfies a particular condition.

More specifically, the CPU 11a controls the moving mechanism 300 with reference to the position of, among the sheets P represented in the captured image, a sheet P that is at the topmost position. The sheet P at the topmost position in the captured image is hereinafter referred to as “topmost sheet PM”.

In other words, the CPU 11a controls the moving mechanism 300 with reference to the position of the topmost sheet PM that is the sheet P at the topmost position among the sheets P represented in the captured image.

In the present exemplary embodiment, sheets P are stacked one on top of another in the top-bottom direction in the container 53. The CPU 11a controls the moving mechanism 300 with reference to the position of the topmost sheet PM that is at the topmost position, in the stacking direction of the sheets P, among those sheets P represented in the captured image.

Herein, the term “topmost sheet PM” refers to one of the sheets P represented in the captured image that is closest to the upper edge 71 (see FIG. 11B) of the captured image, not the first one of the sheets P that is immediately below and closest to the suction unit 100 (see FIG. 1).

In the case illustrated in FIG. 11B, the sheet P denoted by reference sign 11E is the topmost sheet PM, and the CPU 11a controls the moving mechanism 300 with reference to the position of the topmost sheet PM.

Before controlling the moving mechanism 300, the CPU 11a first identifies the distance between the topmost sheet PM in the captured image and a reference position 74, which is predetermined in the captured image.

If the identified distance is greater than a predetermined distance, the CPU 11a activates the moving mechanism 300 to move the image capturer 80.

On the other hand, if the identified distance is smaller than or equal to the predetermined distance, the CPU 11a does not activate the moving mechanism 300, leaving the image capturer 80 unmoved.

The reference position 74 may be, for example, a position defined by a straight line passing through the top-bottom center of the captured image and extending horizontally in the captured image.

The CPU 11a is configured to identify the distance between the reference position 74 and the position of the white pixel closest to the upper edge 71 of the captured image among all white pixels in the captured image (the white pixel closest to the upper edge 71 is hereinafter referred to as “closest white pixel”).

More specifically, focusing on a perpendicular line given relative to the straight-line reference position 74 and passing through the closest white pixel, the length of a portion of the perpendicular line that is between the closest white pixel and the reference position 74 is identified as the distance between the closest white pixel and the reference position 74 by the CPU 11a.

If the absolute value of the identified distance is greater than a predetermined value, the CPU 11a activates the moving mechanism 300 to move the image capturer 80.

More specifically, if the absolute value of the identified distance is greater than the predetermined value and if a value obtained by subtracting the coordinate value of the reference position 74 in the top-bottom direction from the coordinate value of the closest white pixel in the top-bottom direction is a positive value, the CPU 11a activates the moving mechanism 300 to move the image capturer 80 upward.

Thus, the image capturer 80 is moved to, for example, a position 11F illustrated in FIG. 11C.

Specifically, in FIG. 11C, the image capturer 80 is moved to a position in an extension plane of the first one, counting from the top, of the plurality of sheets P contained in the container 53.

More specifically, the image capturer 80 is moved to a position in an extension plane of the first one, counting from the top, of those sheets P that are floated with the air blown by the lateral blowing device 400.

In other words, the image capturer 80 is moved to a position in an extension plane of one of the floating sheets P that is first closest to the suction unit 100 (see FIG. 1) (hereinafter the one floating sheet P is referred to as “closest sheet PK”).

Note that the coordinate value of the closest white pixel in the top-bottom direction and the coordinate value of the reference position 74 in the top-bottom direction are each hereinafter referred to as “top-bottom coordinate value”.

In the present exemplary embodiment, sheets P are stacked one on top of another in the top-bottom direction in the container 53. When the lateral blowing device 400 starts to blow air to such sheets P, the sheets P are floated in the container 53.

Furthermore, the CPU 11a controls the moving mechanism 300 to move the image capturer 80 to a position in the extension plane of the closest sheet PK that is first closest to the suction unit 100 among the sheets P floating in the container 53.

To move the image capturer 80 upward as illustrated in FIG. 11C by using the moving mechanism 300 illustrated in FIG. 9, the image capturer 80 is moved to the upper one, the upper stop position 39A (see FIG. 9), of the two stop positions.

In such a case as well, the image capturer 80 is moved to a position in the extension plane of the closest sheet PK, or to a position closer to the closest sheet PK than before the image capturer 80 is moved.

In the present exemplary embodiment, as to be described below, after the image capturer 80 is moved, actual image capturing is performed by using the image capturer 80.

Then, with reference to the result of the actual image capturing, which of the states illustrated in FIGS. 10A to 10C the sheet stack 54 is in is determined.

In the actual image capturing performed after the image capturer 80 is moved, a captured image such as the one illustrated in FIG. 11D is obtained.

In the captured image illustrated in FIG. 11D, a single sheet P is present as the topmost sheet PM, and the CPU 11a determines that the number of white pixels detected in an area corresponding to the topmost sheet PM is for a single sheet P. In such a case, the number of downward continuous pixels is smaller than or equal to the predetermined threshold.

If the captured image illustrated in FIG. 11D is obtained, the CPU 11a determines that the topmost sheet PM and the second sheet P that is present below the topmost sheet PM are not adhered to each other. In such a case, the CPU 11a determines that the sheet stack 54 is in the state illustrated in FIG. 10B.

In a case (not illustrated) where the number of white pixels detected in an area corresponding to the topmost sheet PM in the captured image illustrated in FIG. 11D is for two or more sheets P, the number of downward continuous pixels counted from the closest white pixel is greater than the predetermined threshold.

In such a case, the CPU 11a determines that the sheet stack 54 is in the state illustrated in FIG. 10C.

Thus, in the case where the number of white pixels detected in an area corresponding to the topmost sheet PM is for two or more sheets P, the CPU 11a determines that the sheet stack 54 is in the state illustrated in FIG. 10C.

If the CPU 11a determines that the sheet stack 54 is in the state illustrated in FIG. 10C, the CPU 11a makes a setting that reduces the output of the lateral blowing device 400 (see FIG. 5). Thus, the sheet stack 54 comes to take a state close to the one illustrated in FIG. 10B.

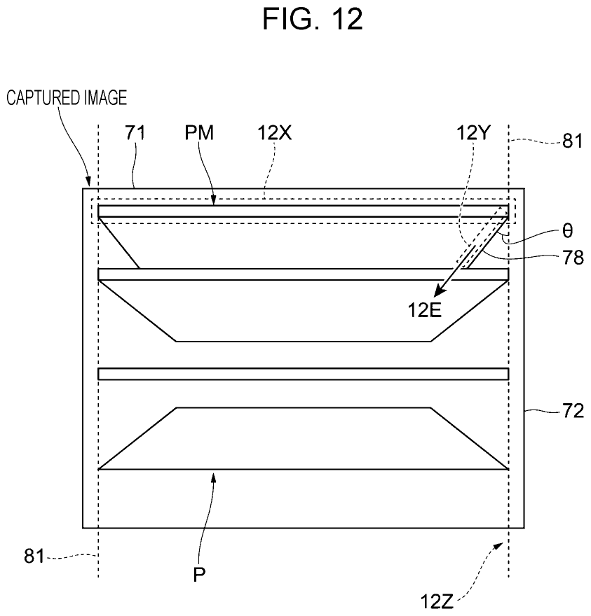

FIG. 12 illustrates how the moving mechanism 300 is controlled with reference to the inclination angle of an edge of a sheet P.

The CPU 11a may be configured to control the moving mechanism 300 with reference to the inclination angle of an edge of one of the sheets P that are represented in the captured image. Specifically, the CPU 11a may be configured to control the moving mechanism 300 with reference to the inclination angle of an edge of, among the sheets P represented in the captured image, a sheet P that satisfies a particular condition.

The sheet P that satisfies a particular condition may be, for example, the topmost sheet PM. In such a case, the CPU 11a controls the moving mechanism 300 with reference to the inclination angle of an edge, 78, of the topmost sheet PM among the sheets P represented in the captured image.

To control the moving mechanism 300 with reference to the inclination angle of the edge 78 of the topmost sheet PM, the CPU 11a determines whether the inclination angle, θ, of the edge 78 of the topmost sheet PM is greater than a predetermined angle.

If the inclination angle θ is greater than the predetermined angle, the CPU 11a activates the moving mechanism 300 to move the image capturer 80.

On the other hand, if the inclination angle θ is smaller than or equal to the predetermined angle, the CPU 11a does not activate the moving mechanism 300, leaving the image capturer 80 unmoved.

If the image capturer 80 is at a position lower than the topmost sheet PM such that the positions of the topmost sheet PM and the image capturer 80 are different in the vertical direction, the inclination angle θ of the edge 78 of the topmost sheet PM is large. That is, identifying the inclination angle θ also identifies the positional relationship between the sheets P and the image capturer 80.

As illustrated in FIG. 12, if the inclination angle θ of the edge 78 is large and is greater than a predetermined threshold, the CPU 11a controls the image capturer 80 to move upward as indicated by an arrow given in FIG. 11C.

Thus, the image capturer 80 is brought close to the extension plane of the closest sheet PK. As described above, the closest sheet PK refers to one of the floating sheets P that is first closest to the suction unit 100 (see FIG. 1).

To identify the edge 78 of the topmost sheet PM in the captured image (see FIG. 12), the CPU 11a first identifies in the captured image a plurality of white pixels that are lined continuously in the horizontal direction at the position closest to the upper edge 71.

Specifically, in the case illustrated in FIG. 12, the CPU 11a identifies in an area 12X a first plurality of white pixels that are lined continuously in the horizontal direction.

Then, the CPU 11a identifies a second plurality of white pixels that are lined continuously upward or downward from, for example, the rightmost one of the first plurality of white pixels that are lined continuously in the horizontal direction.

Specifically, in the case illustrated in FIG. 12, the CPU 11a identifies in an area 12Y a second plurality of white pixels that are lined continuously downward (hereinafter referred to as “right-side continuous white pixels”).

Then, the CPU 11a identifies the angle formed between the line of the above-identified right-side continuous white pixels and a corresponding one of reference lines 81 that is denoted by reference sign 12Z. Furthermore, the CPU 11a defines the thus identified angle as the inclination angle θ of the edge 78 of the topmost sheet PM.

In the case illustrated in FIG. 12, the reference line 81 is a straight line passing through the above rightmost white pixel and is parallel to the right edge, 72, of the captured image.

If the line of the right-side continuous white pixels identified as above extends toward the lower left as indicated by arrow 12E in FIG. 12, the CPU 11a determines that the angle formed between the line of the right-side continuous white pixels and the reference line 81 is a positive angle. Accordingly, the inclination angle θ is a positive angle.

If the line of the right-side continuous white pixels extends toward the upper left (not illustrated), the CPU 11a determines that the angle formed between the line of the right-side continuous white pixels and the reference line 81 is a negative angle. Accordingly, the inclination angle θ is a negative angle.

The image capturer 80 may be at a position higher than the closest sheet PK. In such a case, the line of the right-side continuous white pixels in the captured image extends toward the upper left. In such a case, the CPU 11a determines that the angle formed between the line of the right-side continuous white pixels and the reference line 81 is a negative angle, and accordingly determines that the inclination angle θ is a negative angle.

If the absolute value of the thus identified inclination angle θ is greater than a predetermined value and the identified inclination angle θ is a positive angle, the CPU 11a controls the image capturer 80 to move upward.

In the case illustrated in FIG. 12, the absolute value of the inclination angle θ is greater than the predetermined value, and the inclination angle θ is a positive angle. Therefore, the CPU 11a controls the image capturer 80 to move upward.

In such a case as well, the image capturer 80 is brought close to the extension plane of the closest sheet PK (see FIG. 11C).

The above description relates to cases where the inclination angle θ of the edge 78 of the topmost sheet PM is identified with reference to the right-side continuous white pixels, which are the white pixels that are lined continuously toward the lower left or the upper left from the rightmost one of a plurality of white pixels that are lined continuously in the horizontal direction. However, the identification of the inclination angle θ is not limited to such a scheme.

The inclination angle θ of an edge of the topmost sheet PM may alternatively be identified with reference to a plurality of white pixels that are lined continuously toward the lower right or the upper right from the leftmost one of a plurality of white pixels that are lined continuously in the horizontal direction (the former plurality of white pixels are hereinafter referred to as “left-side continuous white pixels”).

As another alternative, the inclination angle θ of an edge of the topmost sheet PM may be identified as the average of the inclination angle of the edge identified with reference to the right-side continuous white pixels and the inclination angle of the edge identified with reference to the left-side continuous white pixels.

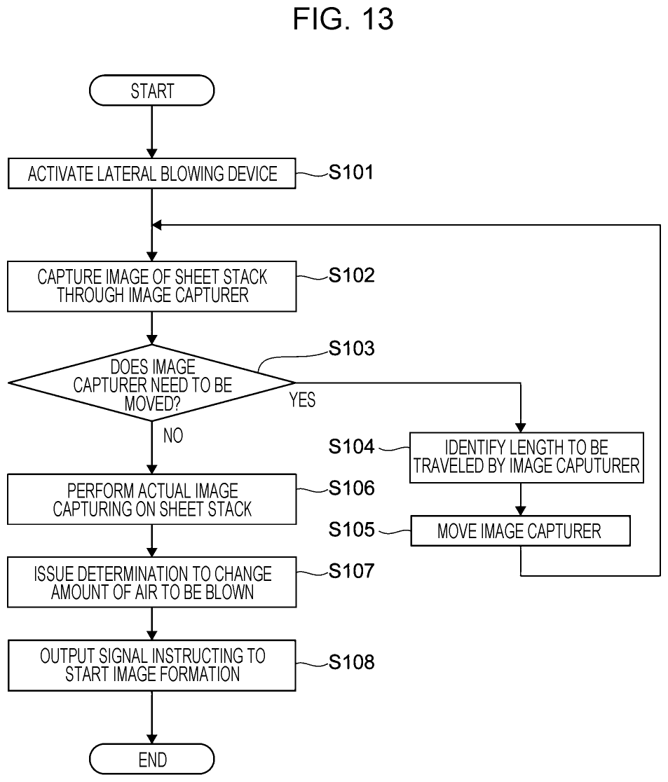

FIG. 13 is a flow chart of a process to be executed by the CPU 11a.

An exemplary process to be executed in the case where the moving mechanism 300 illustrated in FIG. 8 is used will now be described.

In the present exemplary process, the CPU 11a first activates the lateral blowing device 400 (step S101). Thus, the sheets P in the container 53 are floated.

Subsequently, the CPU 11a activates the image capturer 80 to capture an image of the sheet stack 54 by using the image capturer 80 (step S102). Thus, a captured image of the sheet stack 54 is obtained in which the sheets P are floated individually.

Subsequently, the CPU 11a analyzes the captured image and, with reference to the result of the analysis, checks whether the image capturer 80 needs to be moved (step S103). Specifically, the CPU 11a checks whether the image capturer 80 needs to be moved in the stacking direction of the sheets P.

Subsequently, if the CPU 11a determines in step S103 that the image capturer 80 needs to be moved, the CPU 11a identifies the length to be traveled by the image capturer 80 (step S104). The CPU 11a identifies the length to be traveled with reference to the image captured by the image capturer 80.

To identify the length to be traveled, the CPU 11a refers to, for example, the distance between the position of the topmost sheet PM in the captured image and the reference position 74 described above (sec FIG. 11B).

Specifically, the CPU 11a identifies the length to be traveled with reference to the distance between the reference position 74 and the closest white pixel that is closest to the upper edge 71 (see FIG. 11B) of the captured image.

More specifically, in this case, the CPU 11a regards the distance between the closest white pixel and the reference position 74 as the length to be traveled by the image capturer 80.

Alternatively, the CPU 11a identifies the length to be traveled with reference to the inclination angle θ of the edge 78 of the topmost sheet PM (see FIG. 12) in the captured image. In other words, the CPU 11a identifies the length to be traveled with reference to the angle formed between the line of the right-side continuous white pixels and the reference line 81.

In the case where the length to be traveled is to be identified with reference to the inclination angle θ, a relationship table, for example, summarizing the relationship between the inclination angle θ and the length to be traveled by the image capturer 80 is registered in advance in the second storage 91 (see FIG. 2).

If the inclination angle θ identified with reference to the captured image is used, the CPU 11a refers to the relationship table and identifies the length to be traveled by the image capturer 80 with reference to the thus identified inclination angle θ and a corresponding piece of information registered in the relationship table.

Subsequently, the CPU 11a activates the moving mechanism 300 to cause the image capturer 80 to move by the identified length to be traveled (step S105).

Then, the CPU 11a executes step S102 again. Accordingly, the image capturer 80 is activated and captures an image of the sheet stack 54. Thus, another captured image of the sheet stack 54 is obtained.

Subsequently, the CPU 11a executes step S103 again to check, with reference to the captured image obtained in step S102, whether the image capturer 80 needs to be moved.

In step S103, if the CPU 11a determines that the image capturer 80 needs to be moved, the CPU 11a executes step S104 and the subsequent steps again.

After the first run of step S105 for changing the position of the image capturer 80 for the first time, the distance between the closest sheet PK and the image capturer 80 may still be long.

In such a case, it is determined in the second run of step S103 that the image capturer 80 needs to be moved. Accordingly, step S104 and the subsequent steps are executed again.

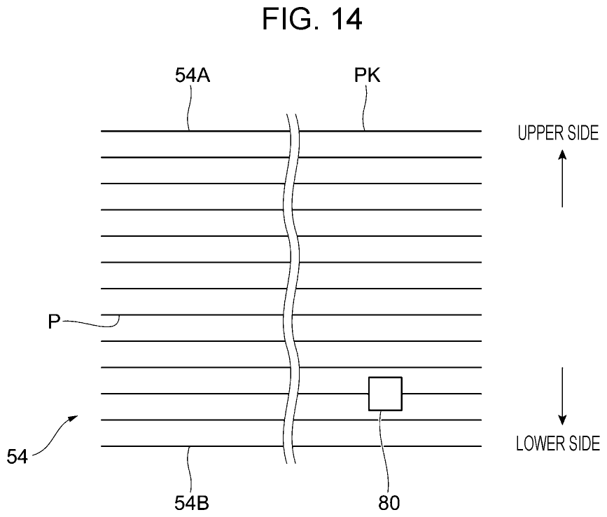

FIG. 14 illustrates the image capturer 80 and a sheet stack 54 in which sheets P are floating. The sheet stack 54 illustrated in FIG. 14 is seen from the side on which the image capturer 80 is located.

In the present exemplary embodiment, as illustrated in FIG. 14, if the image capturer 80 is at a position lower than the closest sheet PK that is at the upper end 54A of the sheet stack 54, the image capturer 80 is moved upward as described above.

Before the image capturer 80 is moved upward, the image capturer 80 may be at a position far away from the closest sheet PK as illustrated in FIG. 14 and near the lower end 54B of the sheet stack 54.

In such a case, only a single run of the upward movement of the image capturer 80 does not bring the image capturer 80 close enough to the closest sheet PK.

In such a case, in the present exemplary embodiment, the above-described step S105 for moving the image capturer 80 is executed a plurality of times to gradually bring the image capturer 80 close enough to the closest sheet PK.

On the other hand, if it is determined in step S103 illustrated in FIG. 13 that the image capturer 80 does not need to be moved, the CPU 11a executes step S106.

In step S106, the CPU 11a activates the image capturer 80 to perform actual image capturing on the sheet stack 54 that is in a floated state.

Subsequently, with reference to the captured image obtained in the actual image capturing, the CPU 11a checks whether the closest sheet PK that is at the first place immediately below the suction unit 100 (see FIG. 1) and a sheet P that is at the second place below the closest sheet PK are adhered to each other.

Specifically, the CPU 11a checks whether the number of downward continuous pixels that is obtained by counting, in the image obtained through the actual image capturing, those white pixels that are lined continuously downward from the closest white pixel that is closest to the upper edge 71 (see FIG. 11D) of the captured image is greater than the predetermined threshold.

If the CPU 11a determines that the number of downward continuous pixels is not greater than the predetermined threshold, the CPU 11a issues a determination to maintain the amount of air to be blown by the lateral blowing device 400.

The number of downward continuous pixels that is not greater than the predetermined threshold indicates that the closest sheet PK at the first place and the sheet P at the second place are not adhered to each other. In such a case, the CPU 11a issues a determination to maintain the setting for the amount of air to be blown by the lateral blowing device 400.

On the other hand, if the CPU 11a determines that the number of downward continuous pixels is greater than the predetermined threshold, the CPU 11a issues a determination to change the amount of air to be blown by the lateral blowing device 400 (step S107).

Specifically, in such a case, the CPU 11a issues a determination to reduce the amount of air to be blown by the lateral blowing device 400 to the sheet stack 54.

The number of downward continuous pixels that is greater than the predetermined threshold indicates that the closest sheet PK at the first place and the sheet P at the second place are adhered to each other. In such a case, the CPU 11a issues a determination to reduce the amount of air to be blown by the lateral blowing device 400.

Thus, the state of the sheet stack 54 changes from the one illustrated in FIG. 10C to the one illustrated in FIG. 10B.

Subsequently, the CPU 11a outputs a signal instructing to start image formation (step S108).

While the above description basically relates to a process to be performed in a case where the image capturer 80 is at a position lower than the closest sheet PK, another case may occur where the image capturer 80 is at a position higher than the closest sheet PK.

In the latter case, as with the case described above, the CPU 11a checks whether the absolute value of the distance between the topmost sheet PM and the reference position 74 is greater than the predetermined value.

If the absolute value is greater than the predetermined value, the CPU 11a controls the image capturer 80 to move.

If the image capturer 80 is at a position higher than the closest sheet PK, the value obtained by subtracting the top-bottom coordinate value of the reference position 74 (see FIG. 11B) from the top-bottom coordinate value of the closest white pixel that is closest to the upper edge 71 of the captured image is a negative value.

In such a case, the CPU 11a controls the image capturer 80 to move downward to bring the image capturer 80 close to the extension plane of the closest sheet PK.

In the case where the image capturer 80 is to be moved with reference to the inclination angle θ of the edge 78 of the topmost sheet PM, if the image capturer 80 is at a position higher than the closest sheet PK, the line of the right-side continuous white pixels extends toward the upper left.

In such a case, the angle formed between the line of the right-side continuous white pixels and the reference line 81 (see FIG. 12) is a negative angle. Accordingly, the inclination angle θ of the edge 78 is a negative angle.

In such a case, the CPU 11a controls the image capturer 80 to move downward to bring the image capturer 80 close to the extension plane of the closest sheet PK.

While the above description relates to a case where the position of the image capturer 80 is adjusted before image formation is started, the position of the image capturer 80 may be adjusted between one run of image formation and another run of image formation that is performed thereafter.

As another alternative, the position of the image capturer 80 may be adjusted if, for example, the kind of sheets P to be transported is changed to another one.

When the kind of sheets P to be transported is changed to another one, the weight of each sheet P and the degree of adhesion between sheets P change, which changes the way sheets P float.

As another alternative, the position of the image capturer 80 may be adjusted every time a predetermined duration is reached or every time the number of sheets P having undergone image formation reaches a predetermined value.

While the above description relates to a case where the position of the image capturer 80 is adjusted automatically, the image capturer 80 may be manually moved by the user in the stacking direction of the sheets P, with the omission of the moving mechanism 300.

If the image capturer 80 is to be manually moved by the user, a guiding element such as a guide rail that guides the image capturer 80 and a fixing mechanism that fixes the image capturer 80 to the guiding element may be provided, for example.

If the image capturer 80 is to be manually moved by the user, the CPU 11a may inform the user through the UI 70 (see FIG. 1) of the length to be traveled by the image capturer 80 that is identified in step S104.

In such a case, the user moves the image capturer 80 by the informed length to be traveled, whereby the image capturer 80 is brought close to the extension plane of the closest sheet PK.

As another alternative, the captured image obtained in step S102 may be provided through the UI 70 to the user.

In such a case, the user by himself/herself identifies the position of the image capturer 80 with reference to the captured image and, if the position of the image capturer 80 is inappropriate, moves the image capturer 80.

The provision of information, such as the length to be traveled and the captured image, to the user is not limited to a scheme implemented through the UI 70 and may be implemented through any device such as a personal computer (PC), a smartphone, or a tablet.

While the above description basically relates to a case where the moving mechanism 300 illustrated in FIG. 8 is used to move the image capturer 80, the above process also basically applies to a case where the moving mechanism 300 illustrated in FIG. 9 is used to move the image capturer 80.

However, the moving mechanism 300 illustrated in FIG. 9 is configured to move the image capturer 80 between two positions: the upper stop position 39A (see FIG. 9) and the lower stop position 39B. Therefore, the image capturer 80 may be incapable of moving to an originally intended location that is further upward or further downward.

In the case where the moving mechanism 300 illustrated in FIG. 9 is used, if, for example, the distance between the closest white pixel that is closest to the upper edge 71 (see FIG. 11B) of the captured image and the reference position 74 is greater than the predetermined threshold and if the value obtained by subtracting the top-bottom coordinate value of the reference position 74 from the top-bottom coordinate value of the closest white pixel is a positive value, the image capturer 80 is to be moved upward as described above.

In such a case, if the image capturer 80 is at the lower stop position 39B (see FIG. 9), the image capturer 80 is moved upward to the upper stop position 39A.

In the case where the moving mechanism 300 illustrated in FIG. 9 is used, if, for example, the distance between the closest white pixel that is closest to the upper edge 71 of the captured image and the reference position 74 is greater than the predetermined threshold and if the value obtained by subtracting the top-bottom coordinate value of the reference position 74 from the top-bottom coordinate value of the closest white pixel is a negative value, the image capturer 80 is to be moved downward.

In such a case, if the image capturer 80 is at the upper stop position 39A, the image capturer 80 is moved downward to the lower stop position 39B.

On the other hand, for example, if the inclination angle θ of the edge 78 (see FIG. 12) of the topmost sheet PM is greater than the predetermined threshold and is a positive value, the image capturer 80 is to be moved upward as described above.

In such a case, if the image capturer 80 is at the lower stop position 39B, the image capturer 80 is moved upward to the upper stop position 39A.

Furthermore, for example, if the inclination angle θ of the edge 78 of the topmost sheet PM is greater than the predetermined threshold and is a negative value, the image capturer 80 is to be moved downward.

In such a case, if the image capturer 80 is at the upper stop position 39A, the image capturer 80 is moved downward to the lower stop position 39B.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A recording-medium-container device comprising:
a container configured to contain a stack of recording media;
a blower configured to blow gas to the recording media contained in the container; and
an image capturer movable in a stacking direction in which the recording media are stacked in the container, the image capturer being configured to capture an image of the recording media while the recording media are being blown with the gas by the blower.
   (((2)))

The recording-medium-container device according to (((1))), further comprising:
a mover including a drive source and configured to move the image capturer in the stacking direction.
   (((3)))

The recording-medium-container device according to (((2))), further comprising:
a processor configured to control the mover,
wherein the recording media in the container are stacked one on top of another in a top-bottom direction, and
wherein the processor is configured to:
   control the mover in such a manner as to position the image capturer in an extension plane of a first one, counting from a top, of the recording media contained in the container.
      (((4)))

The recording-medium-container device according to (((3))),
wherein the processor is configured to:
   position the image capturer in the extension plane of the first recording medium while the first recording medium is floating with the gas blown by the blower.
      (((5)))

The recording-medium-container device according to (((2))), further comprising:
a processor configured to control the mover,
wherein the processor is configured to:
   control the mover with reference to a captured image obtained by the image capturer.
      (((6)))

The recording-medium-container device according to (((5))),
wherein the processor is configured to:
   control the mover with reference to a position of one of the recording media that are represented in the captured image.
      (((7)))

The recording-medium-container device according to (((6))),
wherein the processor is configured to:
   control the mover with reference to a position of, among the recording media that are represented in the captured image, a recording medium that satisfies a particular condition.
      (((8)))

The recording-medium-container device according to (((7))),
wherein the recording media in the container are stacked one on top of another in a top-bottom direction, and
wherein the processor is configured to:
   control the mover with reference to a position of, among the recording media that are represented in the captured image, a topmost recording medium that is present at a topmost position in the captured image.
      (((9)))

The recording-medium-container device according to (((8))),
wherein the processor is configured to:
   activate the mover in such a manner as to move the image capturer if a distance between the topmost recording medium in the captured image and a predetermined reference position in the captured image is greater than a predetermined distance.
      (((10)))

The recording-medium-container device according to (((5))),
wherein the processor is configured to:
   control the mover with reference to an inclination angle of an edge of one of the recording media that are represented in the captured image.
      (((11)))

The recording-medium-container device according to (((10))),
wherein the processor is configured to:
   control the mover with reference to an inclination angle of an edge of, among the recording media that are represented in the captured image, a recording medium that satisfies a particular condition.
   (((12)))

The recording-medium-container device according to (((11))),
wherein the recording media in the container are stacked one on top of another in a top-bottom direction, and
wherein the processor is configured to:
   control the mover with reference to an inclination angle of an edge of, among the recording media that are represented in the captured image, a topmost recording medium that is present at a topmost position in the captured image.
      (((13)))

The recording-medium-container device according to (((12))),
wherein the processor is configured to:
   activate the mover in such a manner as to move the image capturer if the inclination angle of the edge of the topmost recording medium in the captured image is greater than a predetermined angle.
      (((14)))

The recording-medium-container device according to (((1))), further comprising:
a processor configured to identify a length to be traveled by the image capturer if the image capturer is to be moved in the stacking direction.
   (((15)))

The recording-medium-container device according to (((14))),
wherein the processor is configured to:
   identify the length to be traveled with reference to a captured image obtained by the image capturer.
      (((16)))

The recording-medium-container device according to (((15))),
wherein the processor is configured to:
   identify the length to be traveled with reference to a position of one of the recording media that are represented in the captured image.
(((17)))

The recording-medium-container device according to (((15))),
wherein the processor is configured to:
   identify the length to be traveled with reference to an inclination angle of an edge of one of the recording media that are represented in the captured image.
      (((18)))

An image forming apparatus comprising:
a recording-medium-container device configured to contain recording media; and
an image forming section configured to form an image on each of the recording media that is delivered from the recording-medium-container device,
wherein the recording-medium-container device includes the recording-medium-container device according to any one of (((1))) to (((17))).

What is claimed is:

1. A recording-medium-container device comprising:
a container configured to contain a stack of recording media;
a blower configured to blow gas to the recording media contained in the container; and
an image capturer movable in a stacking direction in which the recording media are stacked in the container, the image capturer being configured to capture an image of the recording media while the recording media are being blown with the gas by the blower.

2. The recording-medium-container device according to claim 1, further comprising:
a mover including a drive source and configured to move the image capturer in the stacking direction.

3. The recording-medium-container device according to claim 2, further comprising:
a processor configured to control the mover,
wherein the recording media in the container are stacked one on top of another in a top-bottom direction, and
wherein the processor is configured to:
control the mover in such a manner as to position the image capturer in an extension plane of a first one, counting from a top, of the recording media contained in the container.

4. The recording-medium-container device according to claim 3,
wherein the processor is configured to:
position the image capturer in the extension plane of the first recording medium while the first recording medium is floating with the gas blown by the blower.

5. The recording-medium-container device according to claim 2, further comprising:
a processor configured to control the mover,
wherein the processor is configured to:
control the mover with reference to a captured image obtained by the image capturer.

6. The recording-medium-container device according to claim 5,
wherein the processor is configured to:
control the mover with reference to a position of one of the recording media that are represented in the captured image.

7. The recording-medium-container device according to claim 6,
wherein the processor is configured to:
control the mover with reference to a position of, among the recording media that are represented in the captured image, a recording medium that satisfies a particular condition.

8. The recording-medium-container device according to claim 7,
wherein the recording media in the container are stacked one on top of another in a top-bottom direction, and
wherein the processor is configured to:
control the mover with reference to a position of, among the recording media that are represented in the captured image, a topmost recording medium that is present at a topmost position in the captured image.

9. The recording-medium-container device according to claim 8,
wherein the processor is configured to:
activate the mover in such a manner as to move the image capturer if a distance between the topmost recording medium in the captured image and a predetermined reference position in the captured image is greater than a predetermined distance.

10. The recording-medium-container device according to claim 5,
wherein the processor is configured to:
control the mover with reference to an inclination angle of an edge of one of the recording media that are represented in the captured image.

11. The recording-medium-container device according to claim 10,
wherein the processor is configured to:
control the mover with reference to an inclination angle of an edge of, among the recording media that are represented in the captured image, a recording medium that satisfies a particular condition.

12. The recording-medium-container device according to claim 11,
wherein the recording media in the container are stacked one on top of another in a top-bottom direction, and
wherein the processor is configured to:
control the mover with reference to an inclination angle of an edge of, among the recording media that are represented in the captured image, a topmost recording medium that is present at a topmost position in the captured image.

13. The recording-medium-container device according to claim 12,
wherein the processor is configured to:
activate the mover in such a manner as to move the image capturer if the inclination angle of the edge of the topmost recording medium in the captured image is greater than a predetermined angle.

14. The recording-medium-container device according to claim 1, further comprising:
a processor configured to identify a length to be traveled by the image capturer if the image capturer is to be moved in the stacking direction.

15. The recording-medium-container device according to claim 14,
wherein the processor is configured to:
identify the length to be traveled with reference to a captured image obtained by the image capturer.

16. The recording-medium-container device according to claim 15,
wherein the processor is configured to:
identify the length to be traveled with reference to a position of one of the recording media that are represented in the captured image.

17. The recording-medium-container device according to claim 15,
wherein the processor is configured to:
identify the length to be traveled with reference to an inclination angle of an edge of one of the recording media that are represented in the captured image.

18. An image forming apparatus comprising:
a recording-medium-container device configured to contain recording media; and
an image forming section configured to form an image on each of the recording media that is delivered from the recording-medium-container device,
wherein the recording-medium-container device includes the recording-medium-container device according to claim 1.

19. An image forming apparatus comprising:
a recording-medium-container device configured to contain recording media; and
an image forming section configured to form an image on each of the recording media that is delivered from the recording-medium-container device,
wherein the recording-medium-container device includes the recording-medium-container device according to claim 2.

20. An image forming apparatus comprising:
a recording-medium-container device configured to contain recording media; and
an image forming section configured to form an image on each of the recording media that is delivered from the recording-medium-container device,
wherein the recording-medium-container device includes the recording-medium-container device according to claim 3.
